(19) United States
(12) Patent Application Publication
(10) Pub. No.: US 2003/0043094 A1
(43) Pub. Date: Mar. 6, 2003

(54) Computer display apparatus

(76) Inventors: Hyun-kuk Shin, Suwon-city (KR); Jong-bae Kim, Seoul (KR)

Correspondence Address: SUGHRUE, MION, ZINN, MACPEAK & SEAS, PLLC, 2100 PENNSYLVANIA AVENUE, N. W., WASHINGTON, DC, 20037-3213, US

(21) Appl. No.: 09/822,837

(22) Filed: Apr. 2, 2001

(30) Foreign Application Priority Data
May 4, 2000 (KR) 00-23977

(51) Int. Cl. G09G 3/36

(52) U.S. Cl. 345/87

(57) ABSTRACT

A computer display apparatus is provided, and more particularly, a display apparatus having a graphic card is provided. The computer display apparatus includes an image signal receiving apparatus for receiving graphic information generated in an advanced graphic port (AGP) of a computer system; a graphic card for processing graphic information input through the image signal receiving apparatus and generating an image signal; and a display unit for displaying the image signal generated in the graphic card. As described above, the display apparatus according to the present invention has a graphic card and an image signal receiving apparatus which receives graphic information generated in the AGP port of the computer system, and therefore the resolution of a displayed image can be adjusted in the display apparatus itself.

### BACKGROUND OF THE INVENTION

1. Field of the Invention

The present invention relates to a computer display apparatus, and more particularly, to a computer display apparatus having a graphic card. The present application is based on Korean Patent Application No. 00-23977, filed May 4, 2000, which is incorporated herein by reference.

2. Description of the Related Art

Recently, main boards complying with a bus specification, advanced graphic port (AGP), are widely used. AGP is the bus specification announced by Intel, and has a clock speed and data transmission rate, twice faster than those of peripheral component interface (PCI). While PCI operates at a 33 MHz rate and has a 132 MB/s maximum transmission rate, AGP operates at a 66 MHz rate and has a 264 MB/s maximum transmission rate, twice higher than the rates of PCI.

By raising the clock frequency, AGP does more than just raise the data transmission rate. AGP is not connected to a central processing unit (CPU) through the PCI bus, but is connected to a place between the CPU and a system memory. That is, when a PCI bus has a graphic card as in the existing buses, graphic information calculated by the CPU and a video chip is dispersedly stored in the system memory and the memory of the graphic card connected to the PCI bus. Therefore, in order to display a graphic image on the monitor, traffic between the system memory and PCI bus increases in such a structure.

The transmission rate of the PCI bus can satisfy a network adaptor or SCSI adaptor, but a bottleneck occurs in the PCI bus when the bus is used for a graphic card which ceaselessly sends huge amount of information such as 3-dimension images.

Meanwhile, AGP can send information at a maximum transmission rate because the system memory and graphic card are directly connected to each other in AGP.

A main board supporting AGP requires a graphic card for AGP. The graphic card for AGP is used after being inserted in an AGP port, and converts graphic information processed in the CPU to an RGB image signal used in a display apparatus.

However, as the resolution of a monitor is increasingly heightened, a graphic card supporting such higher resolution is required. That is, when a user buys a monitor, the user has to buy a graphic card appropriate to the monitor, which additionally costs the user a considerable expense.

Therefore, it is preferable that a computer system generates a standardized image signal and resolution is adjusted in the monitor itself.

### SUMMARY OF THE INVENTION

To solve the above problems, it is an object of the present invention to provide an improved computer display apparatus.

To accomplish the above object of the present invention, there is provided a computer display apparatus having an image signal receiving apparatus for receiving graphic information generated in an advanced graphic port (AGP) of a computer system; a graphic card for processing graphic information input through said image signal receiving apparatus and generating an image signal; and a display unit for displaying the image signal generated in said graphic card.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram showing the structure of the existing computer system and display apparatus;

FIG. 2 is a block diagram showing another example of the existing computer and display apparatus; and

FIG. 3 is a block diagram showing a preferable embodiment of the display apparatus according to the present invention.

### DETAILED DESCRIPTION OF THE INVENTION

Hereinafter, embodiments of the present invention will be described in detail with reference to the attached drawings. The present invention is not restricted to the following embodiments, and many variations are possible within the spirit and scope of the present invention. The embodiments of the present invention are provided in order to more completely explain the present invention to anyone skilled in the art.

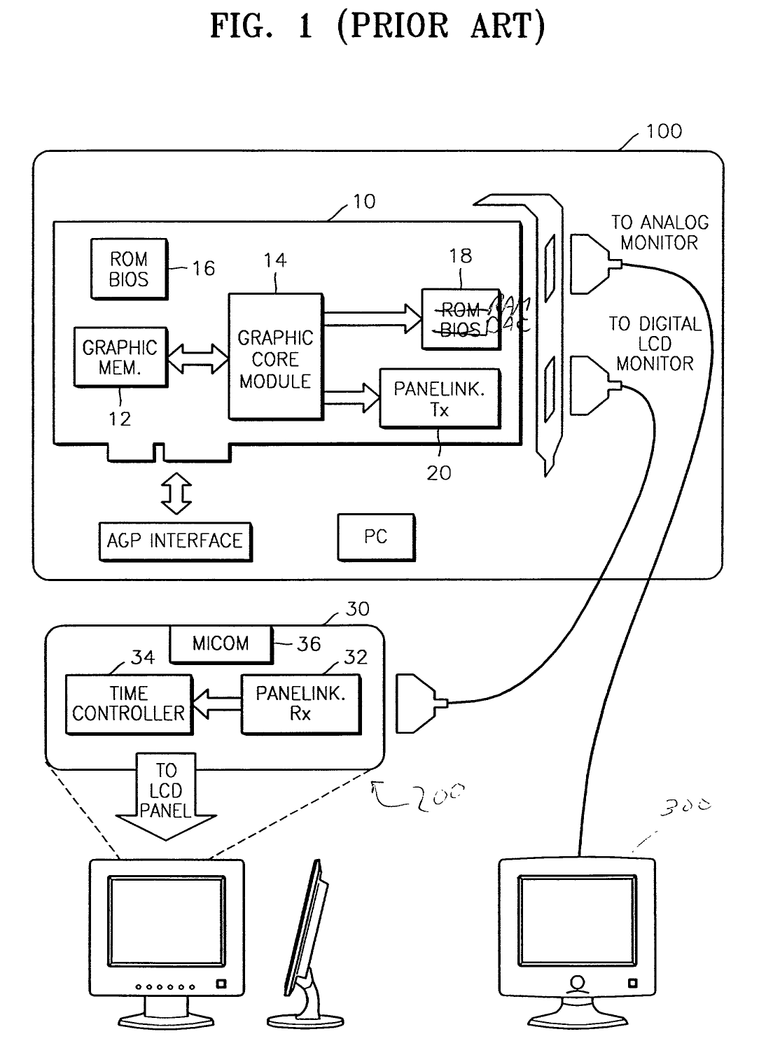

FIG. 1 is a block diagram showing the structure of the existing computer system and display apparatus. Referring to FIG. 1 reference number 100 is a computer system, reference number 200 is a digital display apparatus, and reference number 300 is an analogue display apparatus. The computer system 100 has a graphic card 10 which receives graphic information through an AGP interface, and generates an analogue image signal or digital image signal required for the display apparatus, using the graphic information.

The graphic card 10 is formed by a graphic memory 12, a graphic core unit 14, a ROM BIOS 16, a RAMDAC 18, and a panel link transmission unit 20.

The graphic memory 12 stores graphic information output from a video chip (not shown in drawings) of the computer. The CPU (not shown in drawings) of the computer system 100 sends a screen processing command; a display driver converts the command into a command which can be executed by the video chip; and then the video chip outputs graphic information according to the converted command.

The graphic core unit 14, which is an important component determining the capacity of the graphic card 10, controls the entire graphic card, and plays a role similar to that of the CPU of a computer.

ROM BIOS 16 stores information on the shape, size and location of the cursor appearing on the monitor, and through the information stored here, display of the monitor is quickly carried out.

RAMDAC 18 converts digital data to an analogue signal and its processing capacity is presented by the number of bits and speed.

A panel link transmission unit 20 receives in parallel data of color information output from the graphic core unit 14, a data enable (DE) signal, a control signal, and a clock signal, as input signals, and outputs parallel data after capture and parallel/serial conversion.

The digital display apparatus 200 receives a digital image signal and displays it. A leading example of the digital display apparatus is a liquid crystal display (LCD). The digital display apparatus 200 has an LCD panel control unit 30 which receives a digital image signal and controls the received digital image signal to be displayed on the LCD panel.

The LCD panel control unit 30 includes a panel link receiving unit 32, a time controller 34, and a microprocessor. The panel link receiving unit 32 receives RGB serial image data, which is transmitted from the panel link transmission unit 20 of the computer system 100, a DE signal, a control signal (including a synchronizing signal), and a clock signal, and outputs RGB serial image data after serial/parallel conversion.

The time controller 34 controls timing of horizontal/vertical display. The microprocessor 36 controls the operation of the LCD panel control unit 30.

The analogue display apparatus 300 displays the analogue image signal provided from RAMDAC 18 of the computer system 100.

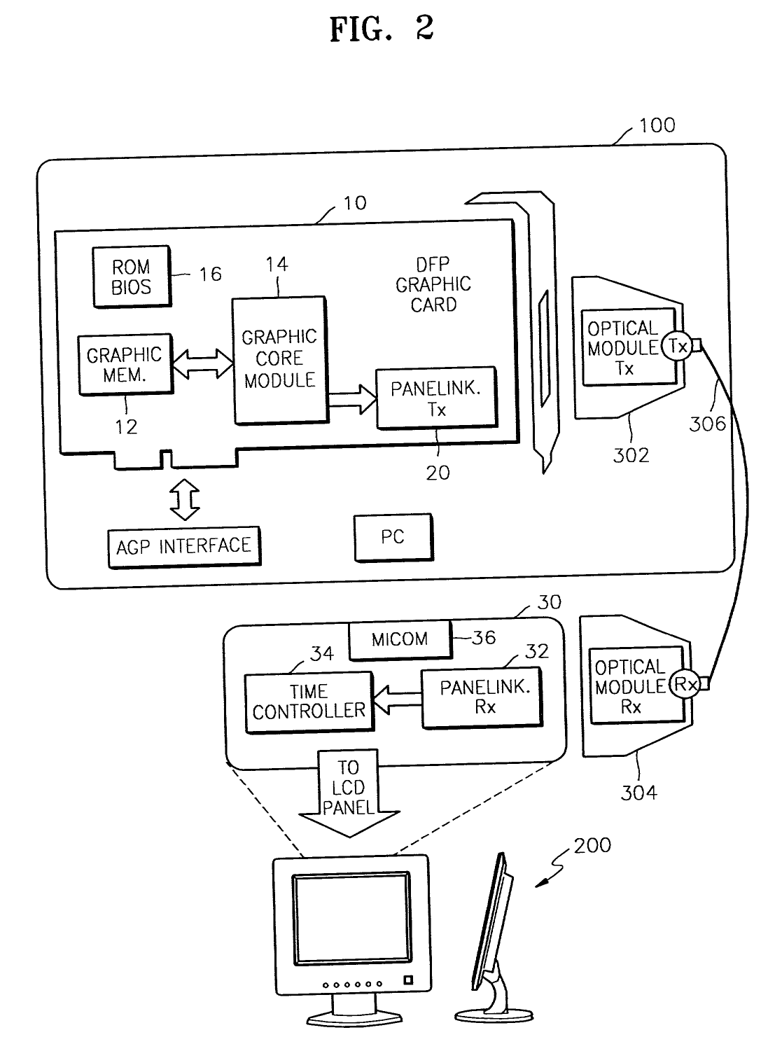

FIG. 2 is a block diagram showing another example of the existing computer and display apparatus. Referring to FIG. 2, a difference between the apparatuses of FIGS. 1 and 2 is that the apparatus of FIG. 2 sends an image signal through an optical transmission and receiving apparatus. That is, in the apparatus of FIG. 2, a digital image signal output from the graphic card 10 is converted into an optical signal by the optical transmission apparatus 302 and sent through the optical fiber 306. The optical signal sent through the optical fiber 306 is converted again into a digital image signal through the optical receiving apparatus 304 and provided to the LCD panel control unit 30.

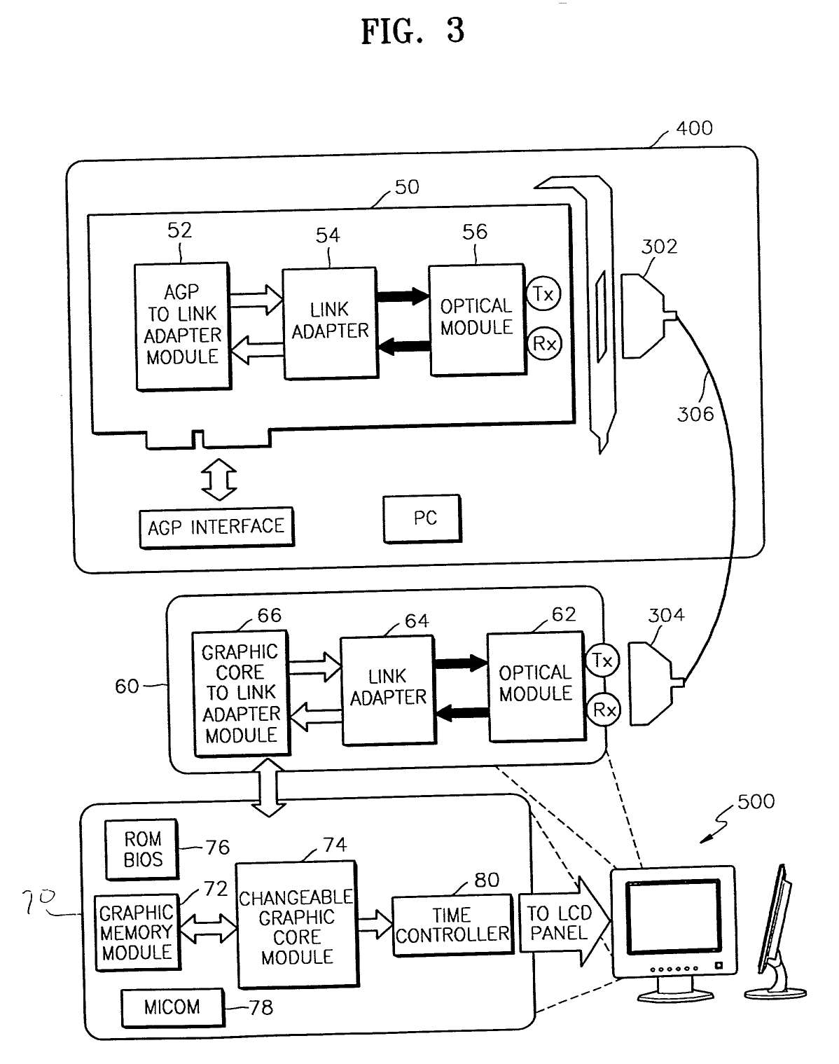

FIG. 3 is a block diagram showing a preferable embodiment of the display apparatus according to the present invention. Referring to FIG. 3, reference number 400 is a computer system, and reference number 500 is a digital display apparatus.

The computer system 400 has an image signal transmission apparatus 50 instead of the existing graphic card, and the display apparatus 500 has an image signal receiving apparatus 60 and a graphic card 70.

The image signal transmission apparatus 50 has an AGP-Link adaptor 52, a link adaptor 54, and a first optical converter 56.

The AGP-Link adaptor 52 converts a bidirectional AGP bus signal to a unidirectional parallel signal. The link adaptor 54 converts unidirectional parallel data, which is provided from the AGP-Link adaptor 52, to serial data.

The first optical converter 56 converts serial data, which is provided from or to the link adaptor 54, to an optical signal.

This image signal transmission apparatus 50 is disclosed in detail in Korean Patent Application Nos. 99-21554 (entitled: A Structural Body of an Electronic Product Combining a Display) and 99-028202 (entitled: An Image Signal Transmission Method) filed by the present applicants.

The image signal receiving apparatus 60 has a second optical converter 62, a link adaptor 64, and a graphic core-Link adaptor 66.

The second optical converter 62 converts an optical signal, which is provided from the first optical converter 56 of the image signal transmission apparatus 50, to serial data, or converts serial data, which is provided by the link adaptor 54, to an optical signal.

The link adaptor 64 converts unidirectional serial data to parallel data. The graphic core-Link adaptor 66 converts unidirectional parallel data to bidirectional parallel data.

The image signal receiving apparatus 60 is disclosed in detail in Korean Patent Application Nos. 99-21554 and 99-028202, mentioned above.

The graphic card 70 has a graphic memory 72, a graphic core unit 74, a ROM BIOS 76, a microprocessor 78, and a time controller 80.

The graphic memory 72 stores graphic information output from the video chip of the computer system. The graphic information is sent from the computer system 400 to the graphic memory 72 through the image signal transmission apparatus 50 and the image signal receiving apparatus 60.

When the CPU of the computer system 400 sends a screen processing command, the display driver converts the command to a command which can be processed by the video chip, and then according to the converted command, the video chip outputs graphic information which is output to the display apparatus.

The graphic core unit 72 is an important component which determines the performance of the graphic card, controls the entire graphic card, and plays a role similar to that of the CPU in a computer.

The ROM BIOS 76 stores information on the shape, size, and location of the cursor appearing on the monitor, and through the information stored here, display of the monitor is quickly carried out.

In the apparatus shown in FIG. 3, the graphic card 70 is drawn in a shape appropriate to an LCD panel, but it can be applied to a cathode ray tube (CRT). A shape appropriate to the CRT is, for example, similar to the graphic card 10 shown in FIG. 1.

The display apparatus of FIG. 3 has an embedded graphic card 70, and the graphic card communicates graphic information with the AGP port of the computer system 400 through the image signal transmission and receiving apparatus.

Therefore, the computer system 400 does not need to have a graphic card.

The functions of the graphic card 70 can be upgraded by upgrading software, or it can be made to be detachable so that it can be swapped.

As described above, the display apparatus according to the present invention has a graphic card and an image signal receiving apparatus which receives graphic information generated in the AGP port of the computer system, and therefore the resolution of a displayed image can be adjusted in the display apparatus itself.

Also, the display apparatus according to the present invention has a dedicated embedded graphic card and therefore it is not necessary to buy a separate graphic card.

What is claimed is:

1. A computer display apparatus comprising:
an image signal receiving apparatus for receiving graphic information generated in an advanced graphic port (AGP) of a computer system;
a graphic card for processing graphic information input through said image signal receiving apparatus and generating an image signal; and
a display unit for displaying the image signal generated in said graphic card.

2. The computer display apparatus of claim 1, wherein said image signal receiving apparatus receives graphic information converted to an optical signal, and demodulates an optical signal to graphic information.

3. The computer display apparatus of claim 1, wherein said display unit is a liquid crystal display (LCD) panel, and the graphic card further includes a time controller for displaying the generated image signal on the LCD panel.
